(19) United States
(12) Patent Application Publication
(10) Pub. No.: US 2014/0152221 A1
(43) Pub. Date: Jun. 5, 2014

(54) MOTOR DRIVING CONTROL APPARATUS AND METHOD, AND MOTOR USING THE SAME

(71) Applicant: SAMSUNG ELECTRO-MECHANICS CO., LTD., Suwon (KR)

(72) Inventor: Joo Yul KO, Suwon (KR)

(73) Assignee: SAMSUNG ELECTRO-MECHANICS CO., LTD., Suwon (KR)

(21) Appl. No.: 13/772,119

(22) Filed: Feb. 20, 2013

(30) Foreign Application Priority Data
Nov. 30, 2012 (KR) 10-2012-0137865

(51) Int. Cl. H02P 6/18

(52) U.S. Cl. CPC H02P 6/182
USPC 318/400.35

(57) ABSTRACT

There are provided a motor driving control apparatus and method, and a motor using the same. The motor driving control apparatus includes: a back-electromotive force detecting unit detecting back-electromotive force generated in a motor apparatus; a zero-crossing calculating unit sampling the back-electromotive force and determining a zero-crossing point using an average value of adjacent sections in the sampled back-electromotive force; and a controlling unit controlling driving of the motor apparatus using the zero-crossing point.

### CROSS-REFERENCE TO RELATED APPLICATIONS

This application claims the priority of Korean Patent Application No. 10-2012-0137865 filed on Nov. 30, 2012, in the Korean Intellectual Property Office, the disclosure of which is incorporated herein by reference.

### BACKGROUND OF THE INVENTION

1. Field of the Invention

The present invention relates to a motor driving control apparatus and method, and a motor using the same.

2. Description of the Related Art

In accordance with the development of motor technology, motors having various sizes have been used in a wide range of technology fields.

Generally, a motor is driven by allowing a rotor to be rotated by a permanent magnet and a coil having polarities changed according to current applied thereto. Initially, a brush type motor in which a rotor is provided with a coil was provided. However, this brush type motor has a problem such as brush abrasion, spark generation, and the like, during the driving of the motor.

Therefore, recently, various types of brushless motors have been in general use. A brushless motor, a direct current (DC) motor driven using an electronic rectifying element instead of a mechanical contact element such as a brush, a commutator, or the like, may include a rotor configured of a permanent magnet and a stator including coils corresponding to a plurality of phases and allowing the rotor to be rotated using magnetic force generated by phase voltages of respective coils.

In order for the brushless motor to be efficiently driven, commutation of the respective phases (coils) of a stator should be performed at an appropriate point. In addition, in order to perform appropriate commutation, a position of the rotor should be recognized.

In order to detect the position of the rotor, according to the related art, an element such as a hall sensor, a resolver, or the like, has been used. However, in this case, there is a limitation in that a driving circuit may become relatively complicated.

In order to complement this limitation, a technology of detecting a position of a phase using back-electromotive force (BEMF) instead of a sensor to drive a brushless motor has been widely used.

However, in the case of the scheme of using back-electromotive force, a predetermined amount of filtering should be performed on the detected back-electromotive force. This filtering may cause a delay. Therefore, a zero-crossing point of the back-electromotive force may be inaccurate due to the delay, such that a phase commutation point may also be inaccurate.

Further, a circuit may be complicated due to a circuit configuration necessary to determine the zero-crossing point.

The following Related Art Documents, relating to the motor as described above, have a limitation in that they fail to address the above-mentioned problems.

### RELATED ART DOCUMENT

(Patent Document 1) Korean Patent No. 10-0189122
(Patent Document 2) Korean Patent No. 10-0631340

### SUMMARY OF THE INVENTION

An aspect of the present invention provides a motor driving control apparatus and method capable of preventing generation of a delay and controlling a motor with a simple configuration by sampling back-electromotive force and determining a zero-crossing point using average values of adjacent sections in the sampled back-electromotive force, and a motor using the same.

According to an aspect of the present invention, there is provided a motor driving control apparatus including: a back-electromotive force detecting unit detecting back-electromotive force generated in a motor apparatus; a zero-crossing calculating unit sampling the back-electromotive force and determining a zero-crossing point using an average value of adjacent sections in the sampled back-electromotive force; and a controlling unit controlling driving of the motor apparatus using the zero-crossing point.

The back-electromotive force may a signal mixed with a driving control signal for the motor apparatus.

The back-electromotive force detecting unit may detect the back-electromotive force without performing predetermined filtering on the back-electromotive force mixed with the driving control signal.

The zero-crossing calculating unit may include: a sampler sampling the back-electromotive force mixed with the driving control signal as a digital value; and a zero-crossing estimator selecting two adjacent sections in a waveform of the back-electromotive force sampled by the sampler and calculating an intermediate point of the two adjacent sections as an estimated zero-crossing point.

The zero-crossing calculating unit may further include a zero-crossing determiner receiving a plurality of estimated zero-crossing points from the zero-crossing estimator, calculating an average of the plurality of estimated zero-crossing points, and determining the calculated average as the zero-crossing point.

The zero-crossing estimator may include: a first register storing times T1 and T2 of the two adjacent sections; an adder adding T1 and T2; and a second register calculating an average value of T1 and T2 when added.

The second register may be a shift register shifting a stored value to calculate the average value.

The controlling unit may perform a control operation to commutate a phase of the motor apparatus at the zero-crossing point to control the driving of the motor apparatus.

According to another aspect of the present invention, there is provided a motor including: a motor apparatus performing a rotation operation according to a driving control signal; and a motor driving control apparatus providing the driving control signal to the motor apparatus to control driving of the motor apparatus and generating the driving control signal using a zero-crossing point of back-electromotive force detected in the motor apparatus.

The motor driving control apparatus may include: a back-electromotive force detecting unit detecting the back-electromotive force generated in the motor apparatus; a zero-crossing calculating unit sampling the back-electromotive force and determining the zero-crossing point using an average value of adjacent sections in the sampled back-electromotive force; and a controlling unit controlling the driving of the motor apparatus using the zero-crossing point.

The back-electromotive force may be a signal mixed with the driving control signal for the motor apparatus, and the zero-crossing calculating unit may determine the zero-crossing point without performing predetermined filtering on the back-electromotive force mixed with the driving control signal.

The zero-crossing calculating unit may include: a sampler sampling the back-electromotive force mixed with the driving control signal as a digital value; and a zero-crossing estimator selecting two adjacent sections in a waveform of the back-electromotive force sampled by the sampler and calculating an intermediate point of the two adjacent sections as an estimated zero-crossing point.

The zero-crossing calculating unit may further include a zero-crossing determiner receiving a plurality of estimated zero-crossing points from the zero-crossing estimator, calculating an average of the plurality of estimated zero-crossing points and determining the calculated average as the zero-crossing point.

According to another aspect of the present invention, there is provided a motor driving control method performed by a motor driving control apparatus controlling driving of a motor apparatus, the motor driving control method including: detecting back-electromotive force mixed with a driving control signal from the motor apparatus; sampling the detected back-electromotive force; and determining a zero-crossing point using an average value of adjacent sections in the sampled back-electromotive force.

The motor driving control method may further include determining the zero-crossing point as a phase commutation point of the motor apparatus to generate the driving control signal.

The determining of the zero-crossing point may include: selecting two adjacent sections in a waveform of the sampled back-electromotive force; calculating an intermediate point of the two adjacent sections as the zero-crossing point; and calculating an average of a plurality of estimated zero-crossing points to determine the zero-crossing point.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration diagram illustrating an example of a motor driving control apparatus;

FIG. 2 is a schematic circuit diagram illustrating an example of a back-electromotive force detecting unit of FIG. 1;

FIG. 3 is a configuration diagram illustrating an example of a motor driving control apparatus according to an embodiment of the present invention;

FIG. 4 is a reference graph illustrating an example of calculating a zero-crossing point according to the embodiment of the present invention;

FIG. 5 is a configuration diagram illustrating an example of a zero-crossing calculating unit of FIG. 3;

FIG. 6 is a configuration diagram illustrating an example of a zero-crossing estimator of FIG. 5;

FIG. 7 is a flowchart illustrating an example of a motor driving control method according to an embodiment of the present invention; and

FIG. 8 is a detailed flowchart illustrating an example of operation S730 of FIG. 7.

### DETAILED DESCRIPTION OF THE EMBODIMENTS

Embodiments of the present invention will now be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

Throughout the drawings, the same reference numerals will be used to designate the same or like components.

Hereinafter, for convenience of explanation, the present invention will be described based on a brushless motor. However, it is obvious that the scope of the present invention is not necessarily limited to the brushless motor.

In addition, hereinafter, a motor itself will be referred to as a motor apparatus 20 or 200, and an apparatus including a motor driving control apparatus 10 or 100 for driving the motor apparatus 20 or 200 and the motor apparatus 20 or 200 will be referred to as a motor.

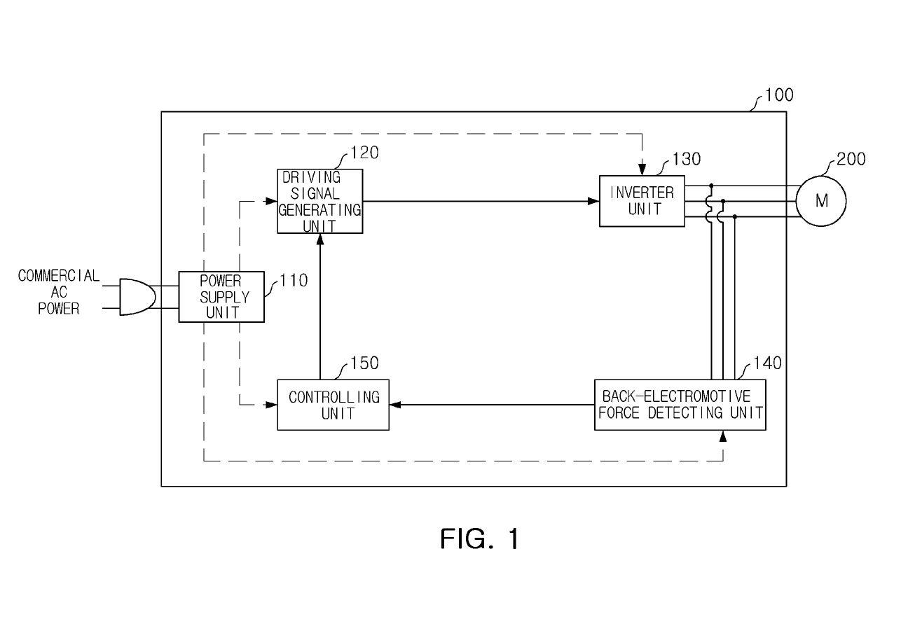

FIG. 1 is a configuration diagram illustrating an example of a motor driving control apparatus.

Referring to FIG. 1, the motor driving control apparatus 100 may include a power supply unit 110, a driving signal generating unit 120, an inverter unit 130, a back-electromotive force detecting unit 140, and a controlling unit 150.

The power supply unit 110 may supply power to the respective components of the motor driving control apparatus 100. For example, the power supply unit 110 may convert commercial alternate current (AC) voltage into direct current (DC) voltage and supply the DC voltage to the respective components. In the example shown in FIG. 1, a dotted line means that predetermined power is supplied from the power supply unit 110.

The driving signal generating unit 120 may provide a driving control signal to the inverter unit 130.

In the embodiment of the present invention, the driving control signal may be a pulse width modulation (PWM) signal. In this case, the driving signal generating unit 120 may apply a variable DC level to a predetermined reference waveform (for example, a triangular wave) to adjust a duty ratio of the PWM signal. For example, as a DC level closer to a low voltage level of the triangular wave is applied, the duty ratio of the PWM signal is increased.

The inverter unit 130 may control an operation of the motor apparatus 200. For example, the inverter unit 130 may provide the DC voltage to any one of a plurality of phases according to the driving control signal to induce generation of magnetic force in coils of the motor apparatus 200.

The back-electromotive force detecting unit 140 may detect back-electromotive force of the motor apparatus 200. In the case in which the motor apparatus 200 is rotated, the back-electromotive force is generated in the coils provided in a rotor. More specifically, the back-electromotive force is generated in the coils, among a plurality of coils, to which the phase voltage is not applied, and the back-electromotive force detecting unit 140 may detect the back-electromotive force generated in the respective coils of the motor apparatus 200 and provide the detected back-electromotive force to the controlling unit 150.

The controlling unit 150 may control the driving signal generating unit 120 to generate the driving control signal using the back-electromotive force provided from the back-electromotive force detecting unit 140. For example, the controlling unit 150 may control the driving signal generating unit 120 to perform phase commutation at a zero-crossing point of the back-electromotive force.

The motor apparatus 200 may perform a rotation operation according to the driving control signal. For example, magnetic fields may be generated in the respective coils of the motor apparatus 200 by the driving current provided from the inverter unit 130. The rotor (not shown) included in the motor apparatus 200 may be rotated by the magnetic fields generated in the coils as described above.

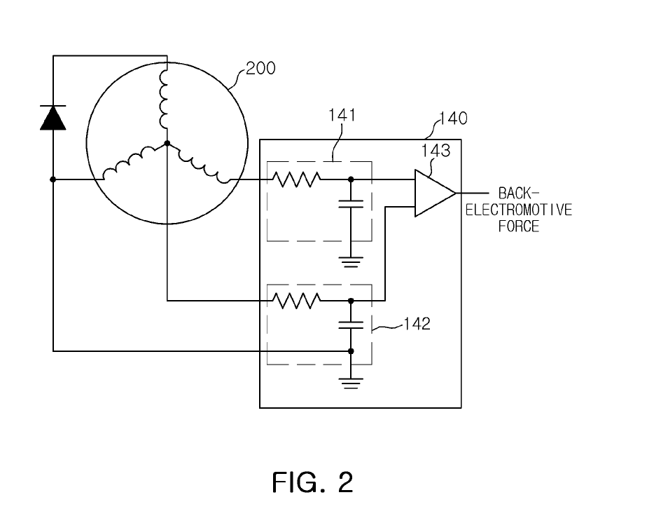

FIG. 2 is a schematic circuit diagram illustrating an example of the back-electromotive force detecting unit of FIG. 1.

The motor apparatus 200 shown in FIG. 2 may include a three-phase coil and may directly obtain voltage from a neutral point of the three-phase coil. However, in another example, the motor apparatus may not obtain the voltage directly from the neutral point, but may also obtain voltage from a virtual neutral point of the three-phase coil.

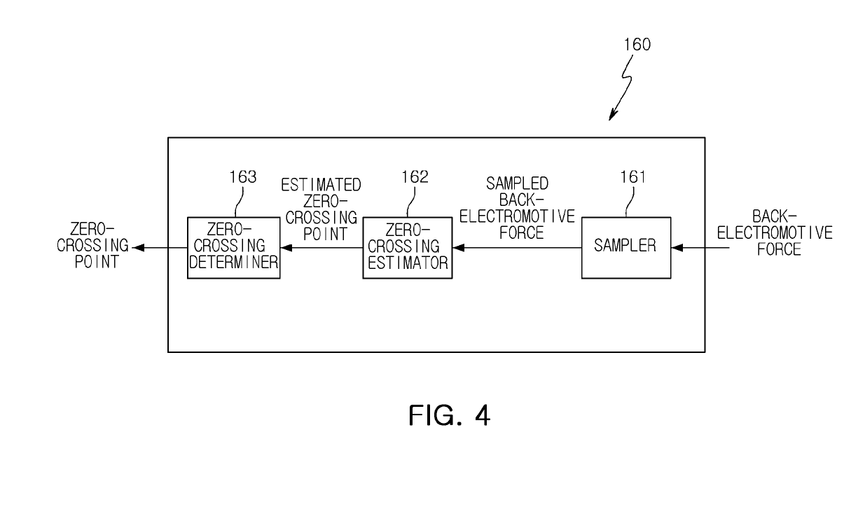

The back-electromotive force detecting unit 140 may compare pole voltages of the respective phases with the neutral point voltage using a comparator 143 to detect the back-electromotive force as shown in FIG. 4. In the example shown in FIG. 2, the back-electromotive force detecting unit 140 may allow the pole voltage and the neutral point voltage to pass through low pass filters 141 and 142 and compare the pole voltage with the neutral point voltage using the comparator 143 to detect the back-electromotive force. The low pass filters 141 and 142 may include a resistor and a capacitor connected to each other in parallel.

The loss pass filters 141 and 142 may be used since the voltage detected in the motor apparatus 200 is mixed with the driving control signal (for example, the PWM signal). Therefore, according to the related art, in order to filter the driving control signal, the low pass filters 141 and 142 have been used in the back-electromotive force detecting unit 140.

However, in this scheme, there is a problem in that a predetermined delay is generated due to the low pass filters 141 and 142. In addition, in order to include the low pass filters 141 and 142, a configuration of the motor driving control apparatus 100 is complicated and a size thereof is increased.

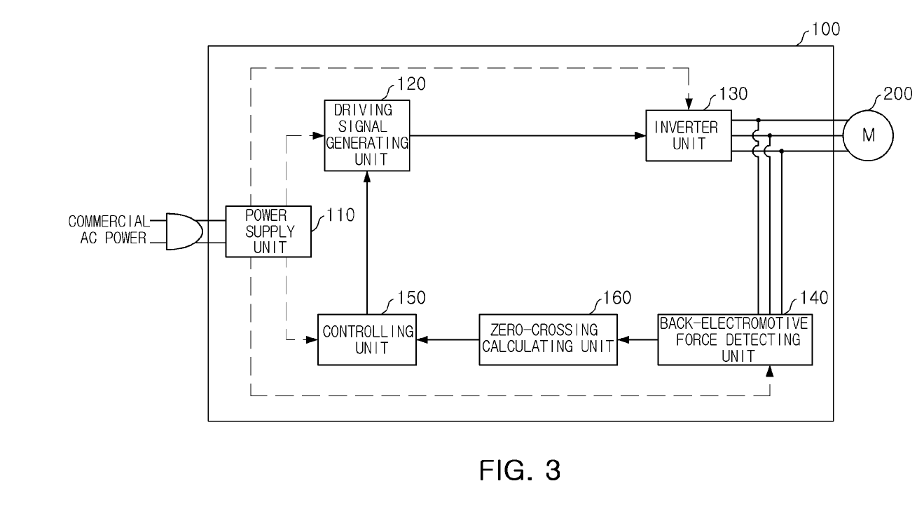

Hereinafter, various embodiments of the present invention will be described with reference to FIGS. 3 through 8.

In a description of various embodiments of the present invention to be described below, an overlapped description of contents the same as or corresponding to contents described above with reference to FIGS. 1 and 2 will be omitted. However, those skilled in the art may clearly understand detailed contents of the present invention from the above-mentioned description.

FIG. 3 is a configuration diagram illustrating an example of a motor driving control apparatus according to an embodiment of the present invention. Here, since the motor apparatus 200 has been described above with reference to FIG. 1, a description thereof will be omitted.

Referring to FIG. 3, the motor driving control apparatus 100 may include a power supply unit 110, a driving signal generating unit 120, an inverter unit 130, a back-electromotive force detecting unit 140, a controlling unit 150, and a zero-crossing calculating unit 160.

The power supply unit 110 may supply power to the respective components of the motor driving control apparatus 100.

The driving signal generating unit 120 may generate a driving control signal of the motor apparatus 200 according to a control of the controlling unit 150. For example, the driving signal generating unit 120 may generate a pulse width modulation (PWM) signal having a predetermined duty ratio.

The inverter unit 130 may provide a driving current to each of the plurality of phases of the motor apparatus 200 according to the driving control signal.

The back-electromotive force detecting unit 140 may detect back-electromotive force generated in the motor apparatus 200.

In the embodiment of the present invention, the back-electromotive force detecting unit 140 may include a plurality of back-electromotive force detectors (not shown) connected to the plurality of phases of the motor apparatus 200, respectively. The back-electromotive force detector may be commonly connected to any one of the plurality of phases and the inverter unit 130.

In the embodiment of the present invention, the back-electromotive force detecting unit 140 may detect back-electromotive force using a back-electromotive force detector connected to a phase that is not currently operated. The reason is that in the case in which a rotor is rotated by a phase to which the driving current is currently provided, the back-electromotive force is induced in the phase that is not currently operated.

In the embodiment of the present invention, the back-electromotive force detecting unit 140 may detect the back-electromotive force without performing predetermined filtering on the back-electromotive force mixed with the driving control signal. That is, the back-electromotive detecting unit 140 may not include a filter such as a low pass filter, or the like.

The controlling unit 150 may control driving of the motor apparatus 200 using a zero-crossing point calculated by the zero-crossing calculating unit 160. For example, the controlling unit 150 may determine a phase commutation point of the motor apparatus 200 using the zero-crossing point and reflect the determined phase commutation point to control the driving signal generating unit 120 to generate the driving control signal.

The zero-crossing calculating unit 160 may determine a zero-crossing point with respect to the back-electromotive force provided from the back-electromotive force detecting unit 140. For example, the zero-crossing calculating unit 160 may sample the back-electromotive force and determine a zero-crossing point using an average value of adjacent sections in the sampled back-electromotive force.

Here, back-electromotive force may be a signal with which the driving control signal for the motor apparatus is mixed. This means that no filter is used in the back-electromotive force detecting unit 140.

The zero-crossing calculating unit 160 will be described below in more detail with reference to FIGS. 4 through 6.

FIG. 4 is a reference graph illustrating an example of calculating a zero-crossing point according to the embodiment of the present invention.

As described above, an example of a signal of the back electromotive force having the driving control signal mixed therewith is shown in FIG. 4. Therefore, the electromotive force may have a predetermined gradient and have a waveform according to a duty ratio.

According to the embodiment of the present invention, the back-electromotive force with which the driving control signal is mixed may be sampled as a digital value. Therefore, it may be appreciated that the waveform of FIG. 4 indicates the back-electromotive force (mixed with the driving control signal) on which the sampling has been performed.

Referring to a circular enlarged view of FIG. 4, since the sampled back-electromotive force has a digital value, a central point of two adjacent sections may be applied as a zero-crossing point. In an example in which the driving control signal is a PWM signal, adjacent ON sections of the PWM signal correspond to the circular enlarged view. That is, when the adjacent ON sections of the PWM signal are represented by a pair of time and voltage, they may be represented by (T1, V1) and (T2, V2). Therefore, an average of the two sections may be calculated to obtain the zero-crossing point.

This may be represented by the following Equation 1:

$${T}_{ZCP} = \frac{( T 1 + T 2 )}{2} \qquad Equation 1$$

That is, since an intermediate value between V1 and V2 corresponds to a voltage V_{ZCP} at the zero-crossing point, the zero-crossing point T_{ZCP} may correspond to an intermediate value between an intermediate point T1 of V1 and an intermediate point T2 of V2.

According to the embodiment of the present invention, this may be reflected to simply calculate the zero-crossing point T_{ZCP}.

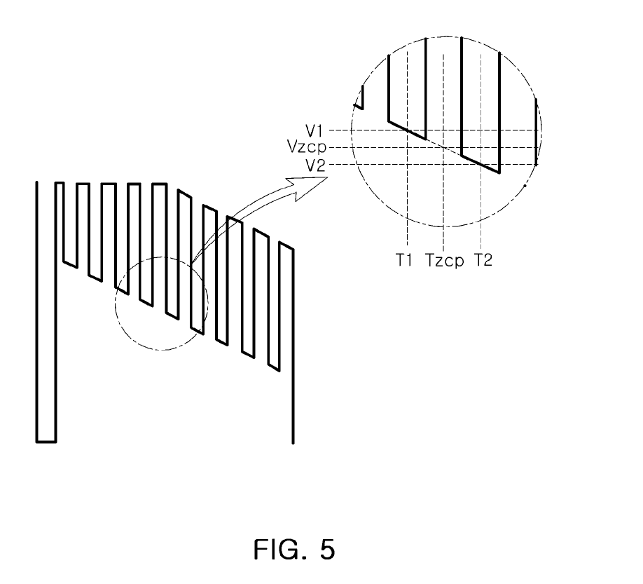

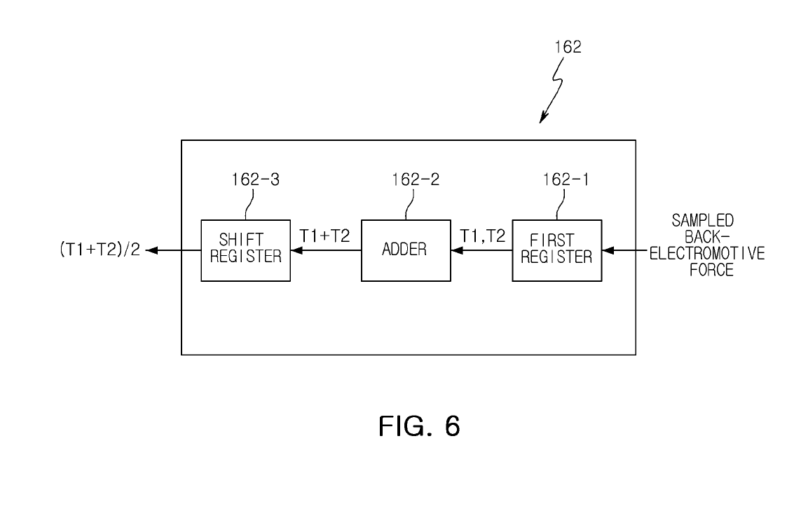

FIG. 5 is a configuration diagram illustrating an example of the zero-crossing calculating unit of FIG. 3; and FIG. 6 is a configuration diagram illustrating an example of a zero-crossing estimator of FIG. 5.

In the example of the zero-crossing calculating unit 160 shown in FIGS. 5 and 6, the zero-crossing point may be calculated as described above with reference to FIG. 4.

A detailed description will be provided with reference to FIGS. 4 through 6. The zero-crossing calculating unit 160 may include a sampler 161, a zero-crossing estimator 162, and a zero-crossing determiner 163.

The sampler 161 may sample the back-electromotive force mixed with the driving control signal as a digital value. The back-electromotive force sampled by the sampler 161 may have the waveform as shown in FIG. 4 by way of example.

The zero-crossing estimator 162 may select two adjacent sections in the waveform of the back-electromotive force sampled by the sampler 161 and calculate an intermediate point of the two adjacent sections as an estimated zero-crossing point.

In the embodiment of the present invention, the zero-crossing point estimated by the zero-crossing estimator 162 may also be used as the zero-crossing point as it is.

In another embodiment of the present invention, an average of zero-crossing points estimated by the zero-crossing estimator 162 may be calculated to determine the zero-crossing point. The averaging of the estimated zero-crossing points as described above may be performed by the zero-crossing determiner 163. In another embodiment of the present invention as described above, the zero-crossing point may be more accurately calculated.

In the embodiment of the present invention, the zero-crossing estimator 162 may be implemented by a simple logic. That is, as shown in FIG. 6, the zero-crossing estimator 162 may include a first register 162-1 storing times T1 and T2 of two adjacent sections, an adder 162-2 adding T1 and T2, and a second register calculating an average value of T1 and T2 when added. Here, the second register may be configured as a shift register 162-3 shifting the stored values to calculate the average value as shown in FIG. 6. In this example, the zero-crossing estimator 162 may be very simply configured. That is, the zero-crossing estimator 162 may be very simply implemented using the adder and the shift register without using a divider or a multiplier.

The zero-crossing determiner 163 may receive a plurality of estimated zero-crossing points from the zero-crossing estimator 162, calculate an average of the plurality of estimated zero-crossing points, and determine the calculated average as the zero-crossing point. For example, the zero-crossing determiner 163 may store the estimated zero-crossing points T_{ZCP} provided from the zero-crossing estimator 162 until it receives a preset number of estimated zero-crossing points T_{ZCP} and average the estimated zero-crossing points T_{ZCP} when it receives the preset number of estimated zero-crossing points T_{ZCP}, thereby determining the zero-crossing point.

In the embodiment of the present invention, the zero-crossing determiner 163 may also be implemented by a simple logic. In an example of using four estimated zero-crossing points, the zero-crossing determiner 163 may include four registers for storing the estimated zero-crossing points, and sum up these four estimated zero-crossing points and then perform shifting using a shift register to simply determine an average value.

To this end, the zero-crossing determiner 163 may determine the zero-crossing point using 2ⁿ estimated zero-crossing points. When the number of estimated zero-crossing points is 2ⁿ, the average value may be simply calculated using the shift register.

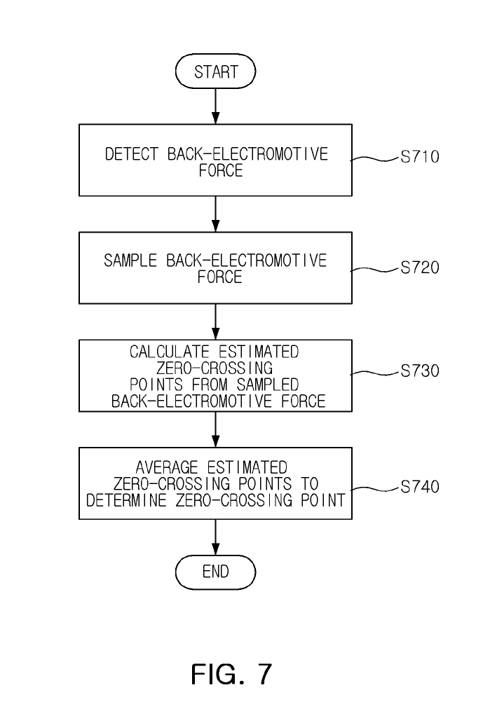

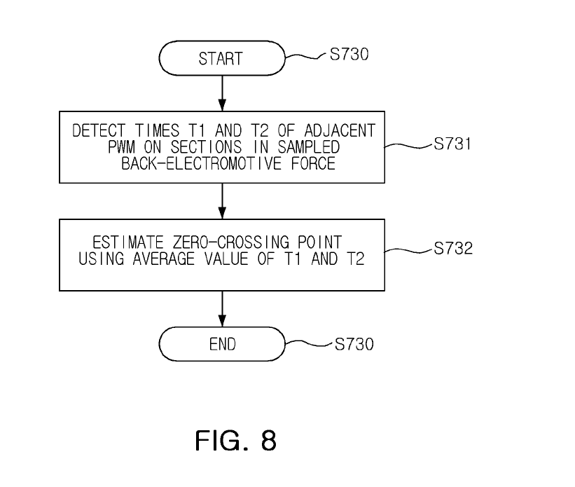

FIG. 7 is a flowchart illustrating an example of a motor driving control method according to an embodiment of the present invention; and FIG. 8 is a detailed flowchart illustrating an example of operation S730 of FIG. 7.

Hereinafter, a motor driving control method according to the embodiment of the present invention will be described with reference to FIGS. 7 and 8. Since the motor driving control method according to the embodiment of the present invention is performed in the motor driving control apparatus 100 described above with reference to FIGS. 3 through 6, an overlapped description of contents the same as or corresponding to the above-mentioned contents will be omitted.

Referring to FIG. 7, the motor driving control apparatus 100 may detect back-electromotive force with which a driving control signal for the motor apparatus 200 is mixed from the motor apparatus 200 (S710).

The motor driving control apparatus 100 may sample the detected back-electromotive force (S720) and determine a zero-crossing point using an average value of adjacent sections in the sampled back-electromotive force (S730 and S740).

That is, the motor driving control apparatus 100 may calculate the estimated zero-crossing points from the sampled back-electromotive force (S730) and average the calculated estimated zero-crossing points to determine the zero-crossing point (S740).

In the embodiment of the present invention, the motor driving control method may further include generating the driving control signal using the zero-crossing point. More specifically, the motor driving control apparatus 100 may determine the zero-crossing point as a phase commutation point of the motor apparatus 200 to generate the driving control signal.

In S730 of FIG. 8, the motor driving control apparatus 100 may detect times T1 and T2 of two adjacent sections in the waveform of the sampled back-electromotive force. The motor driving control apparatus 100 may calculate an intermediate point of the two adjacent sections as the estimated zero-crossing point. Here, the motor driving control apparatus 100 may calculate an average of the plurality of estimated zero-crossing points to determine the zero-crossing point (S740).

As set forth above, according to embodiments of the present invention, back-electromotive force is sampled, and a zero-crossing point is determined using an average value of adjacent sections in the sampled back-electromotive force, whereby generation of a delay may be prevented and a motor may be controlled by a simple configuration.

While the present invention has been shown and described in connection with the embodiments, it will be apparent to those skilled in the art that modifications and variations can be made without departing from the spirit and scope of the invention as defined by the appended claims.

What is claimed is:

1. A motor driving control apparatus comprising:
a back-electromotive force detecting unit detecting back-electromotive force generated in a motor apparatus;
a zero-crossing calculating unit sampling the back-electromotive force and determining a zero-crossing point using an average value of adjacent sections in the sampled back-electromotive force; and
a controlling unit controlling driving of the motor apparatus using the zero-crossing point.

2. The motor driving control apparatus of claim 1, wherein the back-electromotive force is a signal mixed with a driving control signal for the motor apparatus.

3. The motor driving control apparatus of claim 2, wherein the back-electromotive force detecting unit detects the back-electromotive force without performing predetermined filtering on the back-electromotive force mixed with the driving control signal.

4. The motor driving control apparatus of claim 2, wherein the zero-crossing calculating unit includes:
a sampler sampling the back-electromotive force mixed with the driving control signal as a digital value; and
a zero-crossing estimator selecting two adjacent sections in a waveform of the back-electromotive force sampled by the sampler and calculating an intermediate point of the two adjacent sections as an estimated zero-crossing point.

5. The motor driving control apparatus of claim 4, wherein the zero-crossing calculating unit further includes a zero-crossing determiner receiving a plurality of estimated zero-crossing points from the zero-crossing estimator, calculating an average of the plurality of estimated zero-crossing points, and determining the calculated average as the zero-crossing point.

6. The motor driving control apparatus of claim 4, wherein the zero-crossing estimator includes:
a first register storing times T1 and T2 of the two adjacent sections;
an adder adding T1 and T2; and
a second register calculating an average value of T1 and T2 when added.

7. The motor driving control apparatus of claim 6, wherein the second register is a shift register shifting a stored value to calculate the average value.

8. The motor driving control apparatus of claim 1, wherein the controlling unit performs a control operation to commutate a phase of the motor apparatus at the zero-crossing point to control the driving of the motor apparatus.

9. A motor comprising:
a motor apparatus performing a rotation operation according to a driving control signal; and
a motor driving control apparatus providing the driving control signal to the motor apparatus to control driving of the motor apparatus and generating the driving control signal using a zero-crossing point of back-electromotive force detected in the motor apparatus.

10. The motor of claim 9, wherein the motor driving control apparatus includes:
a back-electromotive force detecting unit detecting the back-electromotive force generated in the motor apparatus;
a zero-crossing calculating unit sampling the back-electromotive force and determining the zero-crossing point using an average value of adjacent sections in the sampled back-electromotive force; and
a controlling unit controlling the driving of the motor apparatus using the zero-crossing point.

11. The motor of claim 10, wherein the back-electromotive force is a signal mixed with the driving control signal for the motor apparatus, and
the zero-crossing calculating unit determines the zero-crossing point without performing predetermined filtering on the back-electromotive force mixed with the driving control signal.

12. The motor of claim 10, wherein the zero-crossing calculating unit includes:
a sampler sampling the back-electromotive force mixed with the driving control signal as a digital value; and
a zero-crossing estimator selecting two adjacent sections in a waveform of the back-electromotive force sampled by the sampler and calculating an intermediate point of the two adjacent sections as an estimated zero-crossing point.

13. The motor of claim 12, wherein the zero-crossing calculating unit further includes a zero-crossing determiner receiving a plurality of estimated zero-crossing points from the zero-crossing estimator, calculating an average of the plurality of estimated zero-crossing points and determining the calculated average as the zero-crossing point.

14. A motor driving control method performed by a motor driving control apparatus controlling driving of a motor apparatus, the motor driving control method comprising:
detecting back-electromotive force mixed with a driving control signal from the motor apparatus;
sampling the detected back-electromotive force; and
determining a zero-crossing point using an average value of adjacent sections in the sampled back-electromotive force.

15. The motor driving control method of claim 14, further comprising determining the zero-crossing point as a phase commutation point of the motor apparatus to generate the driving control signal.

16. The motor driving control method of claim 14, wherein the determining of the zero-crossing point includes:
selecting two adjacent sections in a waveform of the sampled back-electromotive force;
calculating an intermediate point of the two adjacent sections as the zero-crossing point; and
calculating an average of a plurality of estimated zero-crossing points to determine the zero-crossing point.
